(19) United States
(12) Patent Application Publication
(10) Pub. No.: US 2022/0343783 A1
(43) Pub. Date: Oct. 27, 2022

(54) CONTENT CONTROL SYSTEM, CONTENT CONTROL METHOD, AND CONTENT CONTROL PROGRAM

(71) Applicant: DWANGO Co., Ltd., Tokyo (JP)

(72) Inventors: Hiroki SHIMOMURA, Tokyo (JP); Emiko YOSHIHARA, Tokyo (JP); Satoshi IGUCHI, Tokyo (JP)

(73) Assignee: DWANGO Co., Ltd., Tokyo (JP)

(21) Appl. No.: 17/760,925

(22) PCT Filed: Oct. 26, 2020
(86) PCT No.: PCT/JP2020/040110

§ 371 Date: Mar. 16, 2022

(30) Foreign Application Priority Data
Nov. 28, 2019 (JP) 2019-215455

(51) Int. Cl. G09B 5/02; G06F 3/01; G06T 13/40; G06T 19/00; G09B 19/06

(52) U.S. Cl. CPC G09B 5/02; G06F 3/011; G06T 13/40; G06T 19/00; G09B 19/06

(57) ABSTRACT

A content control system with at least one processor. The at least one processor specifies a motion of a target virtual object in a virtual space showing a class scene, determines a language expression corresponding to the specified motion with reference to a storage unit that stores a language expression rule, and outputs expression data corresponding to the determined language expression.

### TECHNICAL FIELD

An aspect of the present disclosure relates to a content control system, a content control method, and a content control program.

### BACKGROUND ART

Computer systems that allow users to experience a virtual world are applied in various fields. For example, Patent Document 1 discloses a learning system in which a lecture is given between an instructor-side device and a student-side device. This learning system includes the instructor-side device that includes instructor software using virtual reality technology to draw a three-dimensional virtual space, the student-side device that includes student software using the virtual reality technology, and a network means that transmits and receives lecture signals for drawing the virtual space between the device on the instructor-side device and the student-side device.

### CITATION LIST

### Patent Document

Patent Document 1: JP-A-2009-145883

### SUMMARY OF THE INVENTION

### Technical Problem

A method for effectively communicating events in the virtual space to users is desired.

### Solution to Problem

A content control system according to an aspect of the present disclosure includes at least one processor. The at least one processor specifies a movement of a target virtual object in a virtual space indicating a scene of a class, determines a language expression corresponding to the specified movement with reference to a storage unit that stores a language expression rule, and outputs expression data corresponding to the determined language expression.

In this aspect, the expression data based on the language expression corresponding to the movement of the target virtual object is output. This series of processes which is not described in Patent Document 1 makes it possible to effectively communicate an event in the virtual space to the user of the terminal.

### Advantageous Effects of the Invention

According to an aspect of the present disclosure, it is possible to effectively communicate an event in the virtual space to the user.

### BRIEF DESCRIPTION OF THE DRAWINGS

FIG. 1 is a diagram illustrating an example of the application of a content distribution system (content control system) according to an embodiment.

FIG. 2 is a diagram illustrating an example of a hardware configuration related to the content distribution system according to the embodiment.

FIG. 3 is a diagram illustrating an example of a functional configuration related to the content distribution system according to the embodiment.

FIG. 4 is a flowchart illustrating an example of the operation of the content distribution system according to the embodiment.

FIG. 5 is a diagram illustrating an example of a virtual expression object.

FIG. 6 is a diagram illustrating another example of the virtual expression object.

FIG. 7 is a diagram illustrating still another example of the virtual expression object.

### MODE FOR CARRYING OUT THE INVENTION

Hereinafter, embodiments of the present disclosure will be described in detail with reference to the accompanying drawings. In addition, in the description of the drawings, the same or equivalent elements are denoted by the same reference numerals, and the description thereof will not be repeated.

[Outline of System]

A content control system according to an embodiment is a computer system that controls content distributed to a user. The content means information that is provided by a computer or a computer system and can be recognized by humans. Electronic data indicating the content means content data. An expression format of the content is not limited. For example, the content may be expressed by images (for example, photographs, videos, and the like), documents, voices, music, or any combination of two or more elements of them. The purpose and usage of the content are not limited. For example, the content can be used for various purposes such as entertainment, news, education, medical care, games, chat, commerce, lectures, seminars, and training. The control of the content means a process that is performed to provide the content to the user. The control of the control may include at least one of the generation, editing, storage, and distribution of the content data or may include processes other than those.

The content control system transmits the content data to viewer terminals to provide the content to viewers. For example, the content is provided by a distributor. The distributor is a person who wants to distribute information to the viewers, that is, a sender of the content. The viewer is a person who wants to obtain the information, that is, a user of the content.

In this embodiment, the content is expressed using at least an image. The image showing the content is referred to as a “content image”. The content image means an image in which a person can visually recognize some information. The content image may be a moving image (video) or a still image.

The content image may include the real world or a virtual space. The virtual space means a virtual two-dimensional or three-dimensional space that is expressed by an image displayed on the computer. When the content image includes the virtual space, the content image can be said to be an image showing a scene seen from a virtual camera that is set in the virtual space. The virtual camera is set in the virtual space so as to correspond to the line of sight of the user who sees the content image. The virtual space is expressed by at least one virtual object. The virtual object means an object that does not actually exist in the real world and is expressed only on the computer system.

The content image may include a person who is a performer or may include an avatar instead of the performer. The distributor may appear as the performer on the content image or may not be the performer. At least some of a plurality of viewers may appear as the performers (participants) on the content image. The avatar of the distributor or the participant may appear on the content image. The content images may include both the real world and the virtual space or the virtual object. The inclusion of the virtual space or the virtual object in the content image makes it possible for the viewer to experience augmented reality (AR), virtual reality (VR), or mixed reality (MR).

The avatar is a virtual character of the user expressed by the computer. The avatar is a type of virtual object. The avatar is not a person who was photographed (that is, not the user included in the original image), but is expressed by two-dimensional or three-dimensional computer graphics (CG) using an image material independent of the original image. A method for expressing the avatar is not limited. For example, the avatar may be expressed using an animation material or may be expressed so as to be close to a real thing on the basis of a live image. The avatar may be freely selected by the user (for example, the distributor or the viewer) of the content distribution system.

For example, the content control system may distribute the content to the viewers. The distribution means a process of transmitting information to the user through a communication network or a broadcasting network. In the present disclosure, the concept of the distribution may include broadcasting. In the present disclosure, the content control system having a function of distributing the content is also referred to as a content distribution system.

A method for distributing the content is not limited. For example, the content distribution system may distribute live content. In this case, the content distribution system processes a real-time video provided from the distributor terminal to generate content data and transmits the content data to the viewer terminal in real time. This can be said to be one aspect of live Internet broadcasting. Alternatively, the content distribution system may distribute the video captured and generated in the past. The content distribution system may be used for time shifting that enables the user to view the content in a given period after real-time distribution. Alternatively, the content distribution system may be used for on-demand distribution that enables the user to view content at any time.

In the present disclosure, the expression “transmitting” data or information from a first computer to a second computer means transmission for finally delivering the data or the information to the second computer. Note that this expression also includes a case in which another computer or communication device relays the data or the information in the transmission.

As described above, the purpose and usage of the content are not limited. In this embodiment, it is assumed that educational content is given as an example of the content and the content control system controls educational content data. The educational content is content used to give a class to students and may be used, for example, for a teacher to give a class to students. The teacher means a person who teaches academics, arts, and the like, and the student means a person who receives the teaching. The teacher can be the distributor. The student is an example of the viewer. The teacher may be a person with a teacher's license or a person without a teacher's license. The class means that the teacher teaches the student academics, arts, and the like. The age and affiliation of each of the teacher and student are not limited. Therefore, the purpose and usage of the educational content are not limited. For example, the educational content may be used in various schools such as nursery schools, kindergartens, elementary schools, junior high schools, high schools, universities, graduate schools, vocational schools, preparatory schools, and online schools, or may be used in places or situations other than the schools. In this regard, the educational content can be used for various purposes such as early childhood education, compulsory education, higher education, and lifelong learning.

[Configuration of System]

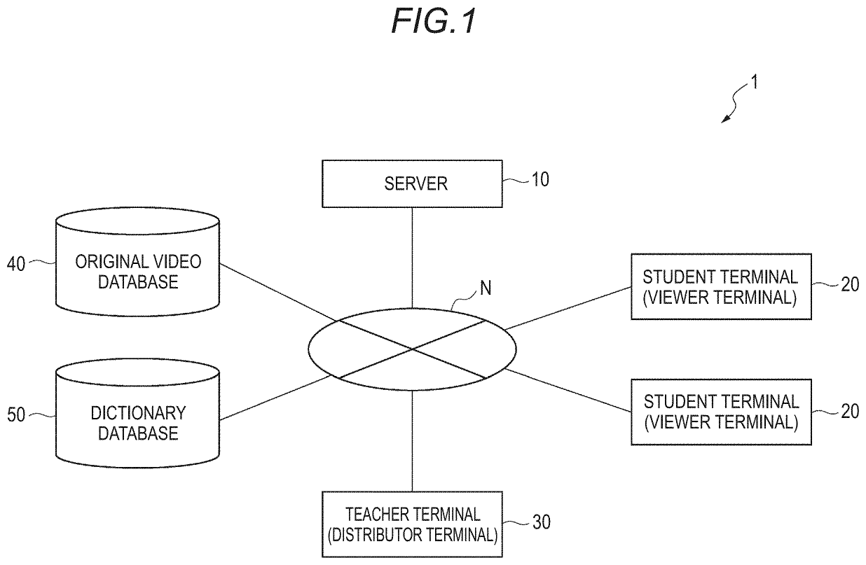

FIG. 1 is a diagram illustrating an example of the application of a content distribution system (content control system) 1 according to the embodiment. In this embodiment, the content distribution system 1 includes a server 10. The server 10 is a computer that generates and distributes content data. For example, the server 10 is connected to at least one student terminal 20, a teacher terminal 30, an original video database 40, and a dictionary database 50 through a communication network N. FIG. 1 illustrates two student terminals 20 and one teacher terminal 30. However, the number of student terminals and the number of teacher terminals are not limited. The configuration of the communication network N is not limited. For example, the communication network N may be configured to include the Internet or may be configured to include an intranet.

The student terminal 20 is a computer used by the student and is an example of the viewer terminal (a computer used by the viewer). For example, the student terminal 20 has a function of accessing the content distribution system 1 and receiving and displaying content data and a function of transmitting motion data of the student to the content distribution system 1. The motion data means electronic data that indicates the movement of an object. The motion data of the student indicates the movement of the body using the position and angle of a particular part (for example, a joint) of the body of the student. A method for acquiring the motion data is not limited. The motion data may be obtained by analyzing a video captured by a camera. Alternatively, the motion data may be obtained by a device for motion capture, such as a body strap, a data glove, or a VR controller (hand controller). The type and configuration of the student terminal 20 are not limited. For example, the student terminal 20 may be a mobile terminal such as a high-performance mobile phone (smartphone), a tablet terminal, a wearable terminal (for example, a head-mounted display (HMD), a smart glass, or the like), a laptop personal computer, or a mobile phone. Alternatively, the student terminal 20 may be a stationary terminal such as a desktop personal computer.

The teacher terminal 30 is a computer that is used by the teacher and is an example of the distributor terminal (a computer used by the distributor). Typically, the teacher terminal 30 is located in a remote place for the student terminal 20. For example, the teacher terminal 30 has a function of capturing a video and a function of accessing the content distribution system 1 and transmitting electronic data (video data) indicating the video. The teacher terminal 30 may have a function of receiving and displaying a video or content. Similarly to the student terminal 20, the teacher terminal 30 may have a function of transmitting motion data of the teacher to the content distribution system 1. The type and configuration of the teacher terminal 30 are not limited. For example, the teacher terminal 30 may be an imaging system having a function of capturing, recording, and transmitting a video. Alternatively, the teacher terminal 30 may be a mobile terminal such as a high-performance mobile phone (smartphone), a tablet terminal, a wearable terminal (for example, a head-mounted display (HMD), a smart glass, or the like), a laptop personal computer, or a mobile phone. Alternatively, the teacher terminal 30 may be a stationary terminal such as a desktop personal computer.

A classroom administrator or a student operates the student terminal 20 to log in to the content distribution system 1, which enables the student to view educational content. The teacher operates the teacher terminal 30 to log in to the content distribution system 1, which enables the teacher to distribute or record his or her classes. In this embodiment, it is assumed that the user of the content distribution system 1 has already logged in.

The original video database 40 is a non-temporary storage device that stores original video data. The original video data is electronic data indicating the original video used for generating the educational content data. Therefore, the original video data can be said to be a material for generating the educational content. The original video may be a live video or may include a virtual space. Since the content of the original video is not limited, the data structure of the original video data is also not limited. For example, in a case in which the live video is used, the original video data includes video data captured by the camera. In a case in which the virtual space is used, the original video data includes spatial data that defines the virtual space and model data that defines the specifications of a virtual object and may further include scenario data for defining the progress of a story in the virtual space. The original video data is stored in the original video database 40 in advance by an arbitrary computer such as the server 10, the teacher terminal 30, or other computers. The original video database 40 can be said to be a library that stores the original video captured or generated in the past (that is, a non-real-time video).

The dictionary database 50 is a non-temporary storage device that stores dictionary data. For example, each record of the dictionary data includes a record ID which is an identifier for identifying the record, a viewer ID which is an identifier for uniquely identifying a student (viewer), and an image (a still image or a moving image) specified by the student.

The installation position of each of the original video database 40 and the dictionary database 50 is not limited. For example, at least one of the original video database 40 and the dictionary database 50 may be provided in a computer system different from the content distribution system 1 or may be a component of the content distribution system 1.

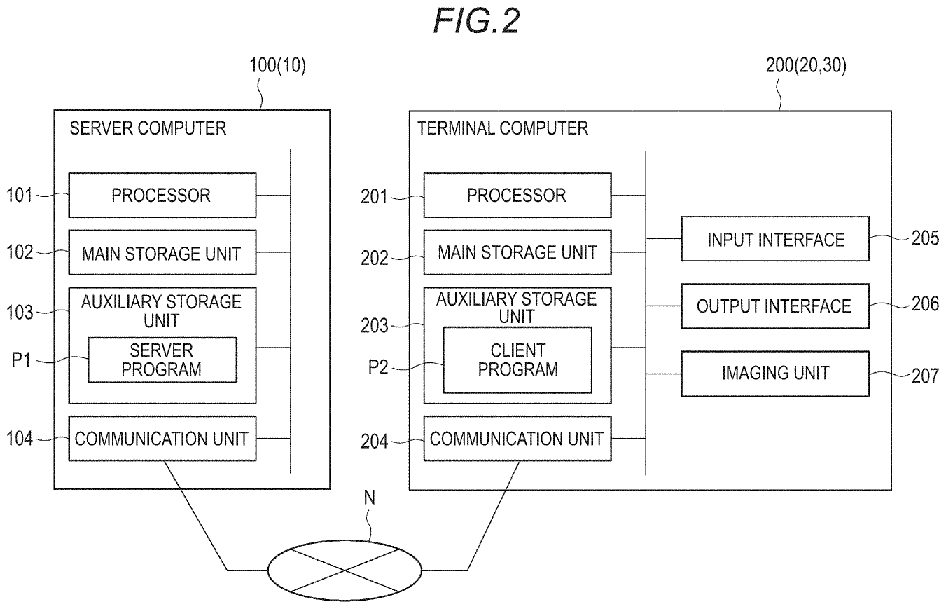

FIG. 2 is a diagram illustrating an example of the hardware configuration of the content distribution system 1. FIG. 2 illustrates a server computer 100 that functions as the server 10 and a terminal computer 200 that functions as the student terminal 20 or the teacher terminal 30.

For example, the server computer 100 includes a processor 101, a main storage unit 102, an auxiliary storage unit 103, and a communication unit 104 as hardware components.

The processor 101 is an arithmetic unit that executes operating systems and application programs. Examples of the processor include a central processing unit (CPU) and a graphics processing unit (GPU). However, the type of the processor 101 is not limited thereto. For example, the processor 101 may be a combination of a sensor and a dedicated circuit. The dedicated circuit may be a programmable circuit, such as a field-programmable gate array (FPGA), or may be other types of circuits.

The main storage unit 102 is a device that stores, for example, a program for implementing the server 10 and a calculation result output from the processor 101. The main storage unit 102 is composed of, for example, at least one of a read only memory (ROM) and a random access memory (RAM).

In general, the auxiliary storage unit 103 is a device that can store a larger amount of data than the main storage unit 102. The auxiliary storage unit 103 is composed of a non-volatile storage medium such as a hard disk or a flash memory. The auxiliary storage unit 103 stores a server program P1 for causing the server computer 100 to function as the server 10 and various kinds of data. For example, the auxiliary storage unit 103 may store data related to at least one of the virtual object, such as an avatar, and the virtual space. In this embodiment, a content control program is implemented as the server program P1.

The communication unit 104 is a device that performs data communication with other computers through the communication network N. The communication unit 104 is composed of, for example, a network card or a wireless communication module.

Each functional element of the server 10 is implemented by loading the server program P1 on the processor 101 or the main storage unit 102 and causing the processor 101 to execute the program. The server program P1 includes codes for implementing each functional element of the server 10. The processor 101 operates the communication unit 104 according to the server program P1 to read and write data from and to the main storage unit 102 or the auxiliary storage unit 103. Each functional element of the server 10 is implemented by this process.

The server 10 may be composed of one or more computers. In a case in which a plurality of computers are used, one server 10 is logically configured by connecting these computers to each other through the communication network.

For example, the terminal computer 200 includes a processor 201, a main storage unit 202, an auxiliary storage unit 203, a communication unit 204, an input interface 205, an output interface 206, and an imaging unit 207 as hardware components.

The processor 201 is an arithmetic unit that executes operating systems and application programs. For example, the processor may be a CPU or a GPU. However, the type of the processor 201 is not limited thereto.

The main storage unit 202 is a device that stores, for example, a program for implementing the student terminal 20 or the teacher terminal 30 and a calculation result output from the processor 201. The main storage unit 202 is composed of, for example, at least one of a ROM and a RAM.

In general, the auxiliary storage unit 203 is a device that can store a larger amount of data than the main storage unit 202. The auxiliary storage unit 203 is composed of a non-volatile storage medium such as a hard disk or a flash memory. The auxiliary storage unit 203 stores a client program P2 for causing the terminal computer 200 to function as the student terminal 20 or the teacher terminal 30 and various kinds of data. For example, the auxiliary storage unit 203 may store data related to at least one of the virtual object, such as an avatar, and the virtual space.

The communication unit 204 is a device that performs data communication with other computers through the communication network N. The communication unit 204 is composed of, for example, a network card or a wireless communication module.

The input interface 205 is a device that receives data on the basis of the operation or manipulation of the user. For example, the input interface 205 is composed of at least one of a keyboard, operation buttons, a pointing device, a microphone, a sensor, and a camera. The keyboard and the operation buttons may be displayed on a touch panel. Since the type of the input interface 205 is not limited, the data to be input is not limited. For example, the input interface 205 may receive data input or selected by the keyboard, the control buttons, or the pointing device. Alternatively, the input interface 205 may receive voice data input by the microphone. Alternatively, the input interface 205 may receive image data (for example, video data or still image data) captured by the camera.

The output interface 206 is a device that outputs data processed by the terminal computer 200. For example, the output interface 206 is composed of at least one of a monitor, a touch panel, an HMD, and a speaker. A display device, such as a monitor, a touch panel, or an HMD, displays the processed data on a screen. The speaker outputs voice indicated by processed voice data.

The imaging unit 207 is a device that captures an image of the real world. Specifically, the imaging unit 207 is a camera. The imaging unit 207 may capture a moving image (video) or a still image (photograph). In a case in which the imaging unit 207 captures a moving image, it processes a video signal on the basis of a given frame rate to acquire a series of frame images arranged in time series as a moving image. The imaging unit 207 can also function as the input interface 205.

Each functional element of the student terminal 20 or the teacher terminal 30 is implemented by loading the corresponding client program P2 on the processor 201 or the main storage unit 202 and causing the processor 201 to execute the program. The client program P2 includes codes for implementing each functional element of the student terminal 20 or the teacher terminal 30. The processor 201 operates the communication unit 204, the input interface 205, the output interface 206, or the imaging unit 207 according to the client program P2 to read and write data from and to the main storage unit 202 or the auxiliary storage unit 203. Each functional element of the student terminal 20 or the teacher terminal 30 is implemented by this process.

At least one of the server program P1 and the client program P2 may be recorded non-temporarily on a tangible recording medium, such as a CD-ROM, a DVD-ROM, or a semiconductor memory, and then provided. Alternatively, at least one of the programs may be provided as data signals superimposed on carrier waves through the communication network. These programs may be provided separately or together.

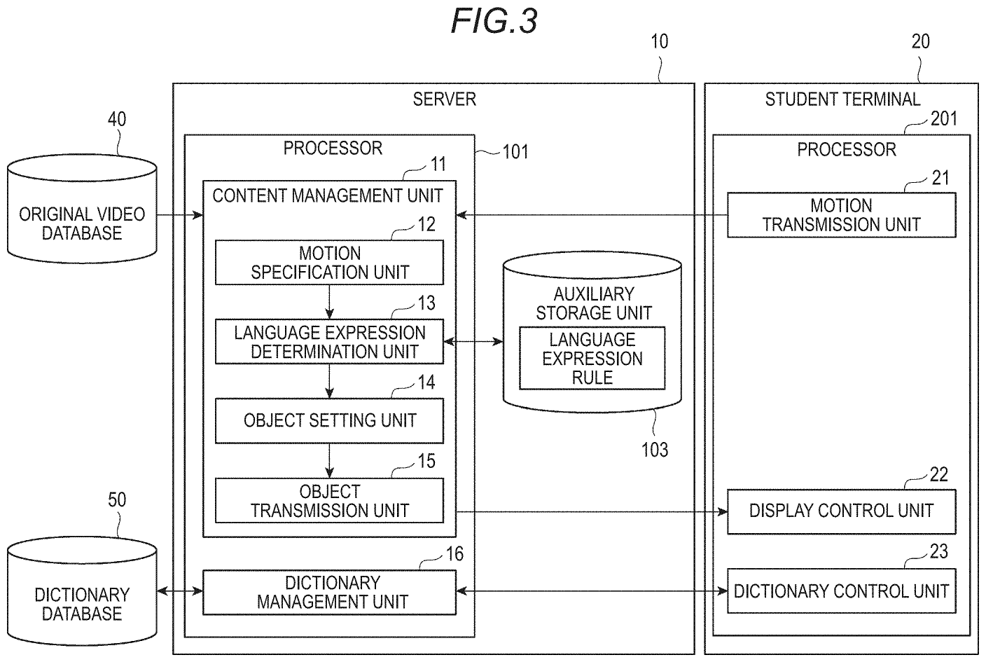

FIG. 3 is a diagram illustrating an example of a functional configuration related to the content distribution system 1. The server 10 includes a content management unit 11, a motion specification unit 12, a language expression determination unit 13, an object setting unit 14, an object transmission unit 15, and a dictionary management unit 16 as functional elements.

The content management unit 11 is a functional element that manages the generation and output of educational content and includes the motion specification unit 12, the language expression determination unit 13, the object setting unit 14, and the object transmission unit 15. The motion specification unit 12 is a functional element that specifies the movement of a virtual object in the virtual space indicating a class scene. In this embodiment, it is assumed that this virtual space is displayed at least on the student terminal 20. The language expression determination unit 13 is a functional element that determines a language expression corresponding to the specified movement. The language expression means the objective expression of meaning by a natural language. For example, the determination of the language expression corresponding to the movement is the language expression of the movement or an event caused by the movement. The object setting unit 14 is a functional element that sets a virtual expression object corresponding to the language expression. The virtual expression object is a virtual object that is used to visualize the language expression and constitutes at least a portion of the educational content data. The virtual expression object is an example of expression data corresponding to the language expression. The object transmission unit 15 is a functional element that transmits the virtual object to the student terminal 20. The transmission is an example of a process of outputting the expression data corresponding to the language expression to the terminal that displays the virtual space. The dictionary management unit 16 is a functional element that manages dictionary data in response to a request from the student terminal 20.

The student terminal 20 includes a motion transmission unit 21, a display control unit 22, and a dictionary control unit 23 as functional elements. The motion transmission unit 21 is a functional element that transmits the motion data of the student to the server 10. The display control unit 22 is a functional element that receives and processes the educational content data and displays the educational content on the display device. The dictionary control unit 23 is a functional element that performs a process related to saving or searching for dictionary data.

[Operation of System]

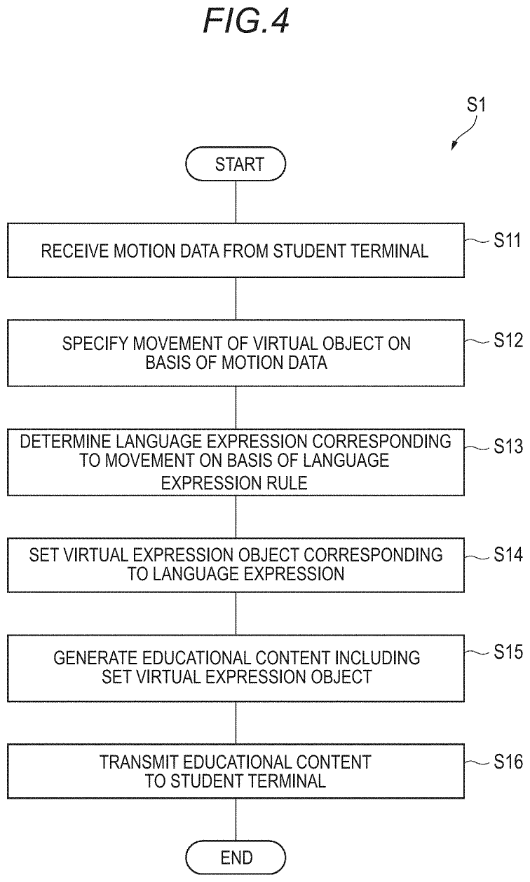

The operation of the content distribution system 1 (specifically, the operation of the server 10) will be described, and a content control method (or a content distribution method) according to this embodiment will be described. FIG. 4 is a flowchart illustrating an example of the operation of the content distribution system 1 as a processing flow S1. In the processing flow S1, it is assumed that the content management unit 11 has already read the original video data requested from the student terminal 20 from the original video database 40 and started to provide the original video data as the educational content data to the student terminal 20.

In Step S11, the content management unit 11 receives the motion data of the student from the student terminal 20. In the student terminal 20, the motion transmission unit 21 transmits motion data indicating the real-time movement of the student viewing the original video to the server 10, and the content management unit 11 receives the motion data. The data structure of the motion data is not limited. For example, the motion data may indicate the movement of the student in a specific time width or may indicate the posture of the student at a specific moment. The motion data may express the movement or posture of any part (for example, only the hand, the whole body, or the like) of the body of the student.

In Step S12, the motion specification unit 12 specifies the movement of the virtual object on the basis of the motion data. In the present disclosure, the virtual object whose movement is specified by the motion specification unit 12 is also referred to as a “target virtual object”. Typically, the target virtual object is a virtual object that is moved by the motion data. For example, in a case in which the motion data indicates the movement of the hand of the student, the target virtual object may be a virtual hand. In a case in which the motion data indicates the movement of the whole body of the student, the target virtual object may be the avatar of the student. For example, the motion specification unit 12 specifies the movement of the target virtual object on the basis of the history of changes in the three-dimensional coordinates of a plurality of joints included in the motion data and combinations (that is, bones) of adjacent joints. The movement of the target virtual object indicates the real-time movement of the student.

In Step S13, the language expression determination unit 13 determines a language expression corresponding to the specified movement on the basis of a language expression rule. The language expression rule is a rule for deriving a language expression from the movement of at least one virtual object. For example, the language expression rule is stored in the auxiliary storage unit 103 in advance. A method for implementing the language expression rule is not limited. For example, the language expression rule may be expressed by data, such as a correspondence table, or may be an algorithm such as a trained model.

The “language expression corresponding to the specified movement” may indicate the movement of the target virtual object or may relate to at least one relevant virtual object that changes on the basis of the movement of the target virtual object. The relevant virtual object may indicate any object. For example, the relevant virtual object may indicate a person (avatar), any artifacts (for example, movables and immovables), any natural objects (for example, animals and plants), or any landforms (for example, mountains, rivers, and the ground). A change in the relevant virtual object is not limited. For example, the change may be a change in position or posture (for example, movement) or a change in state (for example, a change in color). The “language expression corresponding to the specified movement” may indicate a combination of the movement of the target object and the change in the relevant virtual object.

In a case in which it is not possible to determine the language expression in Step S13, that is, in a case in which it is not possible to derive the language expression corresponding to the specified movement, the processing flow S1 ends at this point of time. In this case, the content management unit 11 transmits the original video data to the student terminal 20 without adding a virtual expression object. In a case in which the language expression is determined in Step S13, the process proceeds to Step S14.

In Step S14, the object setting unit 14 sets a virtual expression object corresponding to the determined language expression. As long as the language expression can be visualized, the format of the virtual expression object is not limited. For example, the object setting unit 14 may set a virtual expression object in which the language expression is indicated by letters. In this case, any visual effect, such as decoration or an animation effect, may be applied to the letters. Alternatively, the object setting unit 14 may set a virtual expression object in which the language expression is indicated by an image (still image or moving image) without using letters. This can be said to be a process of setting a typical image showing a scene similar to the specified movement of the virtual object.

The display time of the virtual expression object may be set by any policy. For example, the object setting unit 14 may set a given time limit. Alternatively, the object setting unit 14 may control the virtual expression object such that the virtual expression object is displayed until at least one of the movement of the target virtual object and the change in the relevant virtual object ends.

In Step S15, the object setting unit 14 generates educational content data including the set virtual expression object. For example, the original video data indicates the virtual space. In this case, the object setting unit 14 places the virtual expression object in the virtual space. “Placing an object (such as a virtual expression object)” means placing an object at a determined position, and the concept thereof includes a change the position of the object.

A method for generating the educational content data and the structure of the educational content data are not limited. For example, the content management unit 11 may generate educational content data including virtual space data indicating the virtual space and the position, dimensions, and movement (posture) of the individual object including the virtual expression object. Alternatively, the content management unit 11 may perform rendering based on the set virtual space to generate educational content data. In this case, the educational content data indicates a content image including the virtual expression object.

In Step S16, the object transmission unit 15 transmits the educational content data including the virtual expression object to the student terminal 20. In the student terminal 20, the display control unit 22 receives and processes the educational content data and displays the educational content on the display device. As a result, the virtual expression object appears in the virtual space displayed on the student terminal 20. In a case in which the rendering is not performed in the server 10, the display control unit 22 performs the rendering based on the educational content data and displays the content image. In a case in which the educational content data indicates the content image, the display control unit 22 displays the content image as it is. The student terminal 20 outputs voice from the speaker in accordance with the display of the content image.

The object transmission unit 15 may store the educational content data in a given database, in addition to or instead of transmitting the educational content data to the student terminal 20. For example, the object transmission unit 15 may store the educational content data as the original video data in the original video database 40.

The processing flow S1 may be performed a plurality of times in one distribution operation to a certain student terminal 20. In this case, while the educational content is displayed, various virtual expression objects are displayed at the time of the movement in response to the real-time movement of the student. The processing flow S1 may be performed only for some motion data. For example, the content distribution system 1 may perform the processing flow S1 only for the motion data received in a time width corresponding to a specific scene (for example, a scene in which an exercise is solved) in the educational content.

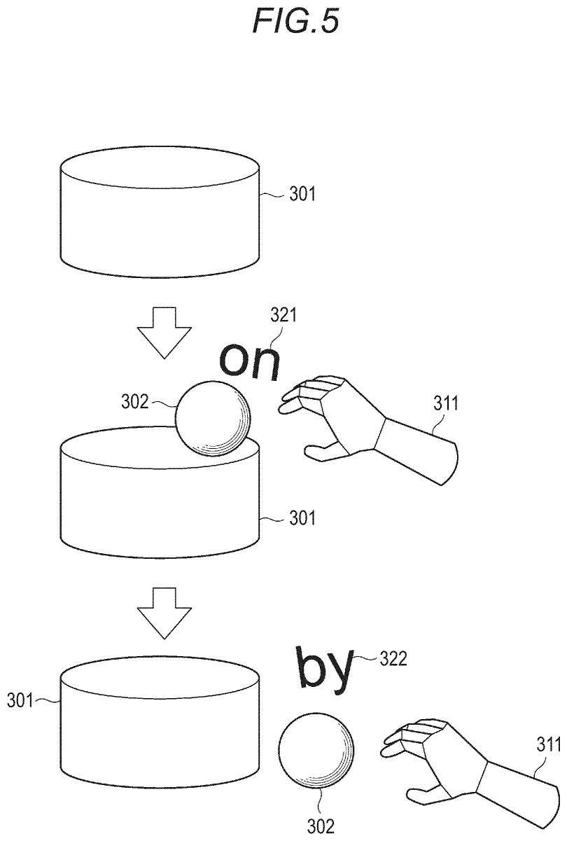

An example of the display of the virtual expression object will be described with reference to FIGS. 5 to 7. FIGS. 5 to 7 are diagrams illustrating examples of the virtual expression object.

The example in FIG. 5 shows a change in situation in a virtual space including three virtual objects of a table 301, a ball 302, and a virtual hand 311. In this example, the content distribution system 1 displays an English preposition indicating the position of the ball 302 with respect to the table 301 with a virtual expression object.

The virtual hand 311 is a target virtual object that moves on the basis of the actual movement of the student's hand. The table 301 and the ball 302 can be treated as the relevant virtual objects. When the student operates the virtual hand 311 to place the ball 302 on the table 301, a virtual expression object 321 is displayed in response to the operation. The virtual expression object 321 is expression data indicating the letters of the preposition “on”, which is a language expression determined corresponding to the placement of the ball 302 “on” the table 301. Then, when the student operates the virtual hand 311 to place the ball 302 near the table 301, a virtual expression object 322 is displayed in response to the operation. The virtual expression object 322 is expression data indicating the letters of the preposition “by”, which is a language expression determined corresponding to the position of the ball 302 “near” the table 301. Both the virtual expression objects 321 and 322 can be said to be related to the relevant virtual objects.

For example, the display of the language expression corresponding to the movement of the target virtual object based on the motion of the student as in the example in FIG. 5 enables a learner to understand a subtle difference in foreign language vocabulary that is generally not easy to understand. For example, in a case in which the ball 302 comes into contact with the table 301 regardless of the direction, a virtual expression object indicating the English word “ON” may be displayed. In a case in which the virtual hand 311 lifts the ball 302 and positions the ball 302 directly above the table 301, the English word “over” may be displayed. In a case in which the virtual hand 311 positions the ball 302 substantially above the table 301, the English word “above” may be displayed. The display of the language expression has a peculiar effect that is not obtained by the conventional education (for example, foreign language education), such as books, the real classes in the classroom, and television educational programs in which the teacher teaches students unilaterally.

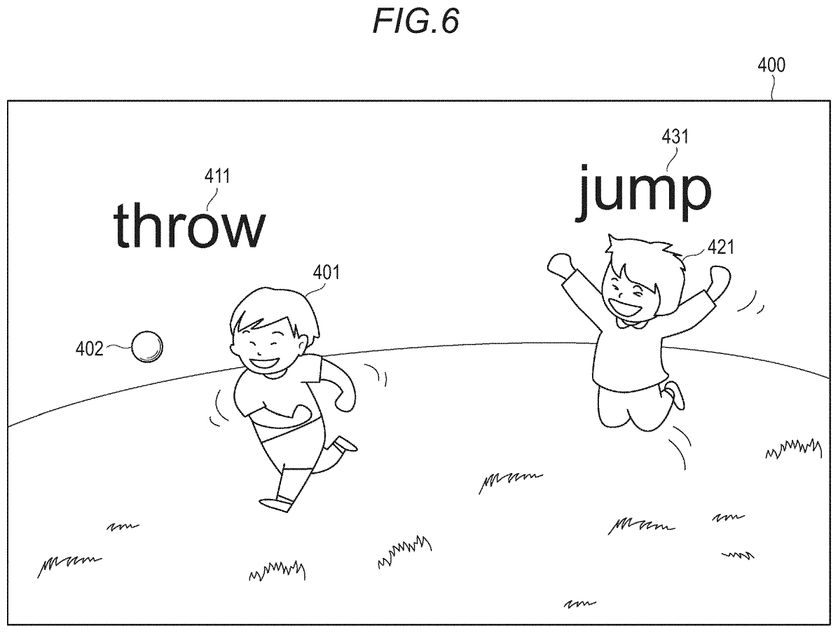

The example of FIG. 6 shows a virtual space 400 including a plurality of avatars corresponding to a plurality of students. In this example, the content distribution system 1 displays English words indicating the movement of the avatars with the virtual expression objects.

The virtual space 400 includes an avatar 401 of a certain student and a ball 402. The avatar 401 is a target virtual object that moves on the basis of the actual movement of the student. The ball 402 can be processed as the relevant virtual object. When the student operates the avatar 401 to throw the ball 402, a virtual expression object 411 is displayed in response to the operation. The virtual expression object 411 is expression data indicating the letters of the verb “throw” which is a language expression determined corresponding to the avatar 401 throwing the ball 402. It can be said that the virtual expression object 411 indicates the movement of the target virtual object.

The virtual space 400 further includes an avatar 421 of another student. The avatar 421 is a target virtual object that moves on the basis of the actual movement of the student. When the student jumps, the avatar 421 also jumps, and the letters of the verb “jump”, which is a language expression determined corresponding to the movement, is displayed as a virtual expression object 431. It can be said that the virtual expression object 431 also indicates the movement of the target virtual object. As in the virtual space 400, the content distribution system 1 may display a virtual expression object corresponding to a language expression caused by the movement of an avatar of a person other than the viewer on the terminal of the viewer.

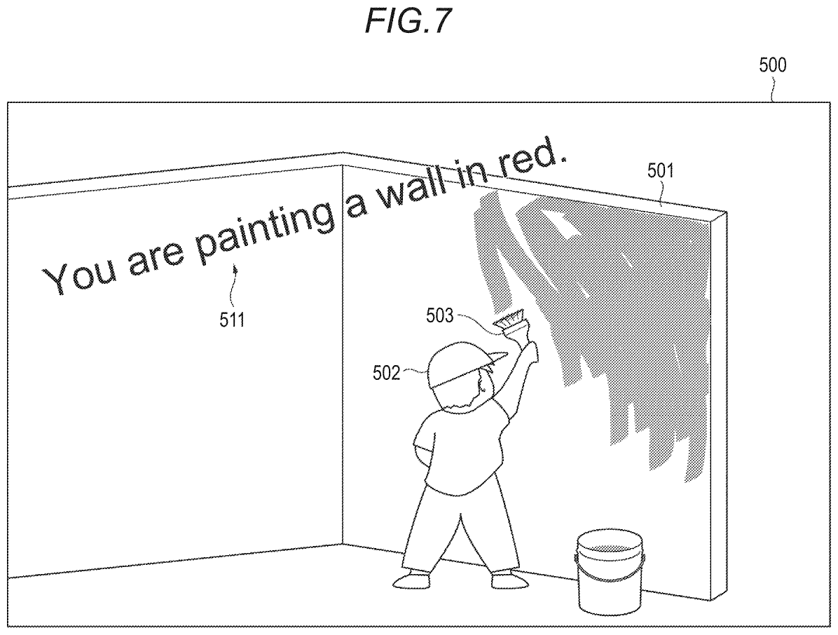

The example of FIG. 7 shows a virtual space 500 that includes an avatar corresponding to a student. In this example, the content distribution system 1 displays an English sentence indicating the behavior of the avatar with a virtual expression object.

The virtual space 500 includes a wall 501, an avatar 502 of a student, and a brush 503 held by the avatar 502. The avatar 502 is a target virtual object that moves on the basis of the actual movement of the student. The wall 501 and the brush 503 can be processed as the relevant virtual objects. When the student operates the avatar 502 to paint the wall 501 in red with the brush 503, a virtual expression object 511 is displayed in response to the operation. The virtual expression object 511 is expression data indicating the letters of the English sentence “You are painting a wall in red.” which is a language expression determined corresponding to the action of painting the wall 501 in red. The virtual expression object 511 can be said to indicate the movement of the target virtual object and can also be said to indicate a combination of the movement of the target virtual object and a change in the relevant virtual object.

As another example, it is assumed that the English sentence “You are painting a wall in red.” is displayed first as a question sentence based on a scenario and the task “You should do this.” in the educational content is presented from the teacher to the student in the educational content. Then, it is assumed that the student has to perform the action of holding the brush 503, selecting red paint from a plurality of colors of paint, loading the brush 503 with the red paint, and painting the wall 501 in the virtual space of the educational content. In a case in which the student has performed the action correctly, the content distribution system 1 may display a virtual expression object indicating a language expression “correct answer” on the basis of the action. In a case in which the student has not performed the action correctly (for example, in a case in which the student has approached a different color of paint), the content distribution system 1 may display a virtual expression object indicating a language expression “Is it really that color?” as a hint on the basis of the action.

In one example, the educational content including the scenes illustrated in FIGS. 5 to 7 is language class content. The application of the content distribution system 1 to a language class makes it possible to inform the student of various matters, such as vocabulary usage and grammar, using the virtual expression object without preparing auxiliary materials for explaining the language. The student can view the virtual expression object to intuitively understand various matters related to the language.

As described above, the purpose and usage of the content are not limited. Therefore, the matters specifically indicated by the virtual expression object are not limited. The virtual expression object may indicate a sentence written in any language other than English. Alternatively, the virtual expression object may indicate matters intended for learning other than language. For example, the virtual expression object may indicate precautions for a given operation in a virtual skill class. The virtual expression object may be used for purposes other than learning. For example, the virtual expression object may be used to support information delivery or communication.

The student who views the educational content provided to the student terminal 20 by the processing flow S1 can register the image of the scene including the virtual expression object as the dictionary data and can refer to the dictionary data later. In this embodiment, the dictionary control unit 23 of the student terminal 20 and the dictionary management unit 16 of the server 10 cooperate to register and refer to (search for) dictionary data.

The student operates the student terminal 20 to specify an image (a still image or a video with a given time width) of a scene including the virtual expression object. In response to the operation, the dictionary control unit 23 records the specified image and transmits a registration request including the image and the viewer ID to the server 10. In the server 10, the dictionary management unit 16 receives the registration request. The dictionary management unit 16 generates a new record ID and associates the viewer ID and the image included in the registration request with the record ID to generate a record of dictionary data. Then, the dictionary management unit 16 stores the record in the dictionary database 50.

Then, at any time, the student operates the student terminal 20 to specify a list of dictionary data or one or more specific records of the dictionary data. In response to the operation, the dictionary control unit 23 transmits a search request including at least the viewer ID to the server 10. In the server 10, the dictionary management unit 16 reads at least one record corresponding to the search request from the dictionary database 50 and transmits the record as a search result to the student terminal 20. In the student terminal 20, the dictionary control unit 23 displays the search result on the display device such that the student can refer to the scenes (for example, the scenes illustrated in FIGS. 5 to 7) including the virtual expression object again.

As described above, the content distribution system 1 can be applied to various types of classes. In one example, the content distribution system 1 can be used for real-time remote classes. The real-time remote class is an aspect in which the class conducted by the teacher in real time is distributed in real time to one or more student terminals 20 through the teacher terminal 30 and the server 10. In this case, since one or more students are viewing common content (for example, a common virtual space) at the same time, it is difficult for all of the students to move a particular virtual object at the same time. Therefore, in this case, it is considered that the teacher or the selected student moves the virtual object or operates in the virtual space.

In another example, the content distribution system 1 can be used for time-shift remote classes. The time-shift remote class is an aspect in which educational content (that is, educational content stored in a given database in advance) captured or generated in advance is distributed to the student terminal 20 in response to a request from each student terminal 20. In this case, the real-time action of a first student is added or overwritten as virtual object information to the educational content data and then stored in a given database. In addition, a virtual expression object corresponding to the language expression based on the action is also added or overwritten to the educational content data and then stored. Then, in a case in which a second student views the educational content, the second student can visually recognize the action of the first student and the language expression (virtual expression object) corresponding to the action. The action of the second student and the virtual expression object corresponding to the language expression based on the action can also be added or overwritten to the educational content data. The time-shift remote class can give each student a pseudo-impression as if different students who are spatially and temporally separated from each other are taking the same class together at the same time.

[Effect]

As described above, the content control system according to one aspect of the present disclosure includes at least one processor. The at least one processor specifies a movement of a target virtual object in a virtual space indicating a scene of a class, determines a language expression corresponding to the specified movement with reference to a storage unit that stores a language expression rule, and outputs expression data corresponding to the determined language expression.

A content control method according to an aspect of the present disclosure is executed by a content control system including at least one processor. The content control method includes a step of specifying a movement of a target virtual object in a virtual space indicating a scene of a class, a step of determining a language expression corresponding to the specified movement with reference to a storage unit that stores a language expression rule, and a step of outputting expression data corresponding to the determined language expression.

A content control program according to an aspect of the present disclosure causes a computer to execute a step of specifying a movement of a target virtual object in a virtual space indicating a scene of a class, a step of determining a language expression corresponding to the specified movement with reference to a storage unit that stores a language expression rule, and a step of outputting expression data corresponding to the determined language expression.

In this aspect, the expression data based on the language expression corresponding to the movement of the target virtual object is output. This expression data makes it possible to effectively communicate an event in the virtual space to the user of the terminal.

In the content control system according to another aspect, the at least one processor may receive motion data indicating a real-time movement of a student who views the class from a terminal and specify the movement of the target virtual object on the basis of the motion data. This process makes it possible to effectively communicate an event corresponding to the real-time movement of the student to the user of the terminal in real time.

In the content control system according to still another aspect, the at least one processor may acquire original video data indicating an original video captured or generated in the past from a database, generate educational content data using the acquired original video data and the expression data, and output the generated educational content data. Since not the real-time video but the existing video is converted into the educational content data using the expression data, it is possible to more effectively use or reuse a huge number of past videos.

In the content control system according to yet another aspect, the at least one processor may determine the language expression indicating the movement of the target virtual object. In this case, it is possible to effectively communicate the movement of the target virtual object to the user.

In the content control system according to still yet another aspect, the at least one processor may determine the language expression related to a relevant virtual object that changes on the basis of the movement of the target virtual object. In this case, it is possible to effectively communicate a change in the movement of the relevant virtual object to the user.

In the content control system according to yet still another aspect, the at least one processor may determine the language expression indicating a combination of the movement of the target virtual object and the change in the relevant virtual object. In this case, it is possible to effectively communicate an event based on a combination of the target virtual object and the relevant virtual object to the user.

In the content control system according to still yet another aspect, the expression data may indicate a virtual expression object displayed on a terminal. In this case, it is possible to visually communicate an event in the virtual space to the user of the terminal.

In the content control system according to yet still another aspect, the virtual expression object may include a letter. An event in the virtual space is expressed with letters, which makes it possible to communicate the event to the user in an easy-to-understand manner.

In the content control system according to still yet another aspect, the at least one processor may acquire a registration request that includes an image including a scene showing the virtual expression object displayed on the terminal and a viewer ID of a student who views the class, may store dictionary data including the viewer ID and the image in a dictionary database, and may read the dictionary data corresponding to a search request from the dictionary database and output the dictionary data to the terminal in response to the search request from the terminal. In this case, since the scene showing the virtual expression objects can be stored and searched, the user can look back at the virtual expression object that the user viewed once.

### Modification Examples

The embodiment of the present disclosure has been described in detail above. However, the present disclosure is not limited to the above-described embodiment. The present disclosure can be modified in various ways without departing from the gist of the present disclosure.

In the above-described embodiment, the motion specification unit 12 specifies the movement of the target virtual object on the basis of the motion data provided from the student terminal (viewer terminal) 20, that is, the motion data indicating the real-time movement of the student (viewer). However, the method for specifying the movement of the target virtual object is not limited thereto. In connection with this configuration, the viewer terminal may not have the function corresponding to the motion transmission unit 21. For example, the motion specification unit 12 may specify the movement of the target virtual object on the basis of the motion data provided from the teacher terminal 30, that is, the motion data indicating the real-time movement of the teacher (distributor). Alternatively, the motion specification unit 12 may specify the movement of the target virtual object included in the original video. For example, the motion specification unit 12 may analyze the original video or refer to the scenario included in the original video data to specify the movement of any target virtual object that has been recorded in advance. The target virtual object selected from the original image may indicate any tangible object or may be at least one of persons (avatars), any artifacts (for example, movables and immovables), any natural objects (for example, animals and plants), and any landforms (for example, mountains, rivers, and the ground).

In the above-described embodiment, the expression data indicates the virtual expression object that can be visually recognized. However, the structure of the expression data is not limited thereto. Therefore, the virtual expression object is not essential. For example, the expression data may be implemented by voice data that indicates a language expression by voice. In this case, the viewer, such as the student, can listen to the language expression.

In the above-described embodiment, the server 10 includes the dictionary management unit 16. However, this functional element is not essential. Therefore, the content control system may not have the function related to the storage and reference of the dictionary data. Correspondingly, the viewer terminal may not have the function corresponding to the dictionary control unit 23.

In the above-described embodiment, the content distribution system 1 is configured using the server 10. However, the content control system may be applied to direct distribution between the user terminals without using the server 10. In this case, each functional element of the server 10 may be implemented in any user terminal. For example, each functional element may be implemented in either the distributor terminal or the viewer terminal. Alternatively, the individual functional elements of the server 10 may be dispersedly implemented in a plurality of user terminals. For example, the individual functional elements may be dispersedly implemented in the distributor terminal and the viewer terminal. In connection with this configuration, the content control program may be implemented as a client program. The content control system may be configured using the server or may be configured without using the server. When the viewer terminal, such as the student terminal, has the function of the server 10, it is possible to provide common educational content to a large number of students while reducing a load on the server. In addition, since information (for example, information indicating motion) on the distributor, such as the student, is not transmitted to the outside of the viewer terminal, it is possible to more reliably protect the confidentiality of viewer information.

As described above, the content control system may control any kind of content other than the educational content. For example, the content control system may control any content for supporting the transmission of any kind of information or communication between the users.

In the present disclosure, the concept of the expression “at least one processor performs a first process, performs a second process, . . . , and performs an n-th process” or an expression corresponding thereto includes a case in which the subject (that is, the processor) performing n processes from the first process to the n-th process changes during the processes. That is, the concept of this expression includes both a case in which all of the n processes are performed by the same processor and a case in which the processor changes according to an arbitrary policy in the n processes.

The processing procedure of the method performed by at least one processor is not limited to the example in the above-described embodiment. For example, some of the above-mentioned steps (processes) may be omitted, or the steps may be performed in a different order. Further, any two or more steps among the above-mentioned steps may be combined, or some of the steps may be modified or deleted. Alternatively, other steps may be performed in addition to each of the above-mentioned steps.

### REFERENCE SIGNS LIST

1 Content distribution system
10 Server
11 Content management unit
12 Motion specification unit
13 Language expression determination unit
14 Object setting unit
15 Object transmission unit
16 Dictionary management unit
20 Student terminal
21 Motion transmission unit
22 Display control unit
23 Dictionary control unit
30 Teacher terminal
40 Original video database
50 Dictionary database
321, 322, 411, 431, 511 Virtual expression object
400, 500 Virtual space
P1 Server program
P2 Client program

1-11. (canceled)

12. A content control system comprising:
at least one processor,
wherein the at least one processor specifies a movement of a target virtual object in a virtual space indicating a scene of a class, determines the language expression corresponding to the specified movement with reference to a storage unit that stores a language expression rule, and outputs expression data corresponding to the determined language expression.

13. The content control system according to claim 12,
wherein the at least one processor receives motion data indicating a real-time movement of a student who views the class from a terminal and specifies the movement of the target virtual object on the basis of the motion data.

14. The content control system according to claim 12,
wherein the at least one processor acquires original video data indicating an original video captured or generated in the past from a database, generates educational content data using the acquired original video data and the expression data, and outputs the generated educational content data.

15. The content control system according to claim 12,
wherein the at least one processor determines the language expression indicating the movement of the target virtual object.

16. The content control system according to claim 12,
wherein the at least one processor determines the language expression related to a relevant virtual object that changes on the basis of the movement of the target virtual object.

17. The content control system according to claim 16,
wherein the at least one processor determines the language expression indicating a combination of the movement of the target virtual object and the change in the relevant virtual object.

18. The content control system according to claim 12,
wherein the expression data indicates a virtual expression object displayed on a terminal.

19. The content control system according to claim 18,
wherein the virtual expression object includes a letter.

20. The content control system according to claim 18,
wherein the at least one processor acquires a registration request including an image including a scene showing the virtual expression object displayed on the terminal and a viewer ID of a student who views the class, stores dictionary data including the viewer ID and the image in a dictionary database, and reads the dictionary data corresponding to a search request from the dictionary database and outputs the dictionary data to the terminal in response to the search request from the terminal.

21. A content control method that is executed by a content control system including at least one processor, the content control method comprising:
a step of specifying a movement of a target virtual object in a virtual space indicating a scene of a class;
a step of determining the language expression corresponding to the specified movement with reference to a storage unit that stores a language expression rule; and
a step of outputting expression data corresponding to the determined language expression.

22. A content control program that causes a computer to execute:
a step of specifying a movement of a target virtual object in a virtual space indicating a scene of a class;
a step of determining the language expression corresponding to the specified movement with reference to a storage unit that stores a language expression rule; and
a step of outputting expression data corresponding to the determined language expression.
